(19) United States
(12) Patent Application Publication
(10) Pub. No.: US 2019/0356744 A1
(43) Pub. Date: Nov. 21, 2019

(54) TRANSFORMING A SHORTENED LINK BASED UPON SOCIAL EVENT FOR TRACKING SHARING ANALYTICS

(71) Applicant: International Business Machines Corporation, Armonk, NY (US)

(72) Inventors: Jeremy A. Greenberger, San Jose, CA (US); Lisa Seacat DeLuca, Baltimore, MD (US); Jeremy R. Fox, Georgetown, TX (US); Kelley Anders, East New Market, MD (US)

(73) Assignee: International Business Machines Corporation, Armonk, NY (US)

(21) Appl. No.: 15/982,256

(22) Filed: May 17, 2018

(51) Int. Cl. H04L 29/08; G06F 17/30; G06Q 50/00

(52) U.S. Cl. CPC H04L 67/22; G06Q 50/01; H04L 67/306; G06F 17/30887

(57) ABSTRACT

Tracking sharing analytics for a shortened link includes receiving a network link referencing a network address associated with a network resource. A first shortened link is generated from the received network link. The first shortened link is mapped to a mapped shortened link. The first mapped shortened link includes a unique association of the shortened link with a first user. The first mapped shortened link is posted to a social media site.

### TECHNICAL FIELD

The present invention relates generally to a method, system, and computer program product for tracking the reach of a shortened link. More particularly, the present invention relates to a method, system, and computer program product for transforming a shortened link based upon a social event for tracking sharing analytics.

### BACKGROUND

Link shortening websites, such as bit.ly by Bitly™ are growing in popularity. Link shortening is a technique in which a Uniform Resource Locator (URL) may be made substantially shorter and still direct to a network resource referenced by the original URL. There are a number of advantages to using a shortened link over use of a full-fledged URL link. A major advantage of the use of a link shortener service over a full URL is the ability to view statistics regarding how well the link is performing. Today, the statistics might show where a link was followed, how many times the link was followed, the operating system of the devices that followed the link, the type of devices that followed the link, or even what times of day the link was followed. However, today, when a link is created it isn't possible to share the link on social media and track the social influence from a single sharing user. While it is possible to track impressions and total engagements with the content identified by the link it is not possible to determine if the clicks came from, for example, Bob's share or Mary's reshare of the link using the link shortening statistics.

Social influence or social reach is the ability for a single user to share content with a wide audience of viewers. Many companies look for social influencers to understand how to share information about their products and even pay them for messages. However, it is difficult to trace how influence is shared amongst social contents.

### SUMMARY

The illustrative embodiments provide a method, system, and computer program product. An embodiment of a method for tracking sharing analytics for a shortened link includes receiving a network link referencing a network address associated with a network resource, and generating a first shortened link from the received network link. The embodiment further includes mapping the first shortened link to a first mapped shortened link. In the embodiment, the first mapped shortened link includes a unique association of the shortened link with a first user. The embodiment further includes posting the first mapped shortened link to a social media site.

An embodiment further includes generating a unique identifier associated with the first user, the first mapped shortened link including the unique identifier. An embodiment further includes appending the unique identifier to the first shortened link to generate the first mapped shortened link.

An embodiment further includes determining that the first mapped shortened link has been re-shared by a second user. An embodiment further includes generating a second unique identifier associated with the second user, and mapping the first shortened link to a second mapped shortened link, the second mapped shortened link including the second unique identifier associated with the second user.

An embodiment further includes generating sharing analytics for the first shortened link. In the embodiment, the sharing analytics includes information tracking re-sharing of the shortened link by the second user. An embodiment further includes providing the sharing analytics to the first user. In an embodiment, the sharing analytics includes a social influence of subsequent users that share the first shortened link.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example configuration for transforming a shortened link based upon a social event for tracking sharing analytics in accordance with an illustrative embodiment;

FIG. 4 depicts an example shortened link sharing sequence in accordance with an illustrative embodiment; and

FIG. 5 depicts a flowchart of an example process for transforming a shortened link based upon a social event for tracking sharing analytics in accordance with an embodiment.

### DETAILED DESCRIPTION

The illustrative embodiments used to describe the invention generally address and solve the above-described problems and other problems related to tracking sharing analytics of a shortened link such as a reach of the shortened link. Various embodiments describe a method, system, and computer program product for transforming a shortened network link based upon a social event for tracking sharing reach. In one or more embodiments, the social event includes sharing a shortened network link on a social media site or platform. In an embodiment, a shortened link, such as a shortened URL, is transformed based upon a social media network event in order to identify tracking analytics such as the reach of the shortened link across a social network. In a particular embodiment, tracking analytics are generated according to events, locations, and/or activity of the original link creator/shortener as well as when and where a subsequent user reshares the shortened link.

In an embodiment, a user submits a link referencing a network address of a network resource to a link shortening service or application, such as Bit.ly, and the link shortening service generates a shortened link. In the embodiment, the user shares the shortened link on a social media site such as Facebook™ or Twitter™. In the embodiment, upon the user pressing save for a “post” or “tweet,” the application re-maps the shortened in the content body to another shortened link unique associated with the user. In one or more embodiments, the remapped shortened link includes an identifier associated with the user. In the embodiment, the content body of the post is saved and displayed to viewers of the content on the social media site. In the embodiment, another user re-shares the remapped shortened link such as by re-sharing, re-tweeting, or re-posting the remapped shortened link, to the same or another social media site. In the embodiment, the application again remaps the shortened link to include an identifier associated with the re-sharing user and posts the re-shared link to the social media site. In an embodiment, the application generates tracking analytics of the reach of the shortened link shared by the original user as well as any re-shares of the shortened link. In the embodiment, the original user is able to view the analytics of how the original link was regenerated and where the most activity was derived to view and the most influential individuals to re-share the content. In one or more embodiments, a user that re-shares/re-tweets/re-posts the shortened link can view analytics from the location of the post.

In an example use case, Bob is a marketing manager for his brand, BigBlueProducts. He is planning to make a social media campaign on Facebook™ with links to the BigBlueProducts website in order to encourage people to buy BigBlueProducts products, in this case, the Watson Magic Hat. Bob submits the URL www.bigblueshop.com/product1 to a link shortening system/application, and the system/application converts the URL to a shortened link to bit.ly/123. Bob can now use this shortened link in a social media post to Facebook™. Sherry, who loves BigBlueShop decides she wants to share Bob's post with her friends by re-posting the post on her Facebook™ wall. The system/application automatically transforms the shortened link in the original post (in this case “bit.ly/123”) to a new URL bit.ly/456. Without such transformations as described in various embodiments, Bob can only obtain simple analytics on how the link was clicked but is only able to view how other people take the link and re-shared it. In the example, Box is able to view how others were influenced to share the link with their followers/friends to determine each person's reach.

In accordance with an embodiment, an application changes a shortened link each time the shortened link is re-shared to provide an understanding of the extent and/or reach of content, for example to determine if content is “going viral.” For example, if 100 people re-tweet a link, the content author may determine the real source of the content going viral as indicated by the share path by a viral calculation on demand. As a result, a real growth driver can be determined (e.g., 5% Twitter™, 10% LinkedIn™, 85% Facebook™). Such analytics data enables the ability of a user to utilize this path/type of marketing or promotion for more growth opportunities in the future for a particular business model.

In an embodiment, the shortened link manipulation operations described herein may be further optimized to report categories for an entire list of links and subordinate links that have been created. In the embodiment, the subordinate links can be monitored for potential actions such as further future postings or potential actions to be taken by the original content author/poster. In particular embodiments, a pyramid hierarchical organization is implemented to control, modify, push to, and/or pull from the master original link down to all of the subordinate links in the lower levels of the pyramid structure. In such embodiments, the original link creator is provided with the ability to view, for example, that a re-shared link is at third level down the pyramid from the original link as a shared link of a shared link all linking back to the original link content.

An embodiment can be implemented as a software application. The application implementing an embodiment can be configured as a modification of an existing health status detection system, as a separate application that operates in conjunction with an existing health status detection system, a standalone application, or some combination thereof.

The illustrative embodiments are described with respect to certain types of network links, URLs, link shortening procedures and algorithms, services, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

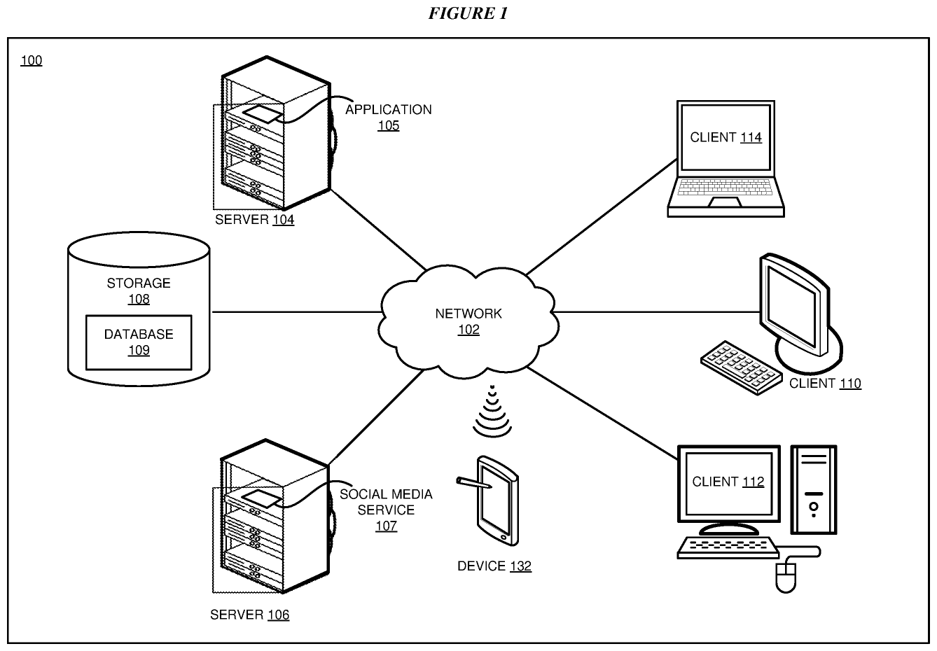

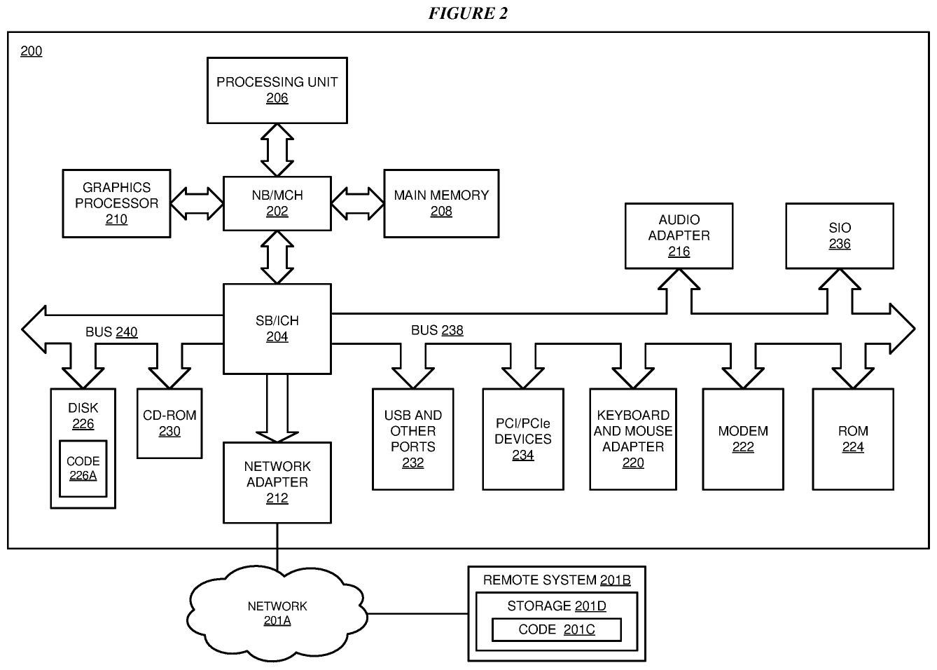

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Device 132 includes a client application 134 configured to perform functions of client application 134 described herein. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Servers 104 and 106, storage unit 108, and clients 110, 112, and 114, and device 132 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown. Server 104 includes an application 105 that may be configured to implement one or more of the functions described herein for transforming a shortened link based upon a social event for tracking sharing analytics in accordance with one or more embodiments.

Server 106 includes a social media service 107 configured to allow users to post links such as shortened links and associated content to a social media site to allow viewing of the content and re-sharing of shortened links by viewers of the shortened links as described herein with respect to various embodiments. Storage device 108 includes one or more databases 109 configured to store data such as user profile information.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications. Data processing environment 100 may also take the form of a cloud, and employ a cloud computing model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as application 105 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. in another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

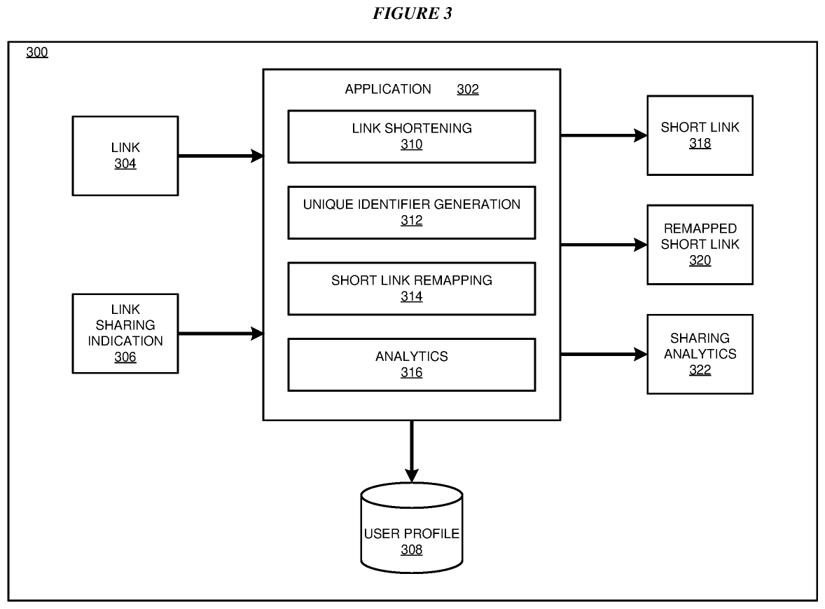

With reference to FIG. 3, this figure depicts a block diagram of an example configuration 300 for transforming a shortened link based upon a social event for tracking sharing analytics in accordance with an illustrative embodiment. The example embodiment includes an application 302. In a particular embodiment, application 302 is an example of application 105 of FIG. 1.

Application 302 includes a link shortening component 310, a unique identifier generation component 312, a short link remapping component 314, and an analytics component 316. In the embodiment, application 302 receives a link 304 from an original user and link shortening component 310 generates a shortened link 318. In the embodiment, the original user posts shortened link 318 to a social media site, and application 302 receives a link sharing indication 306 indicative of the user sharing shortened link 318. In response to receiving link sharing indication 306, unique identifier generation component 312 generates a unique identifier associated with the user using user profile information 308, and shortened link remapping component 314 remaps shortened link 318 to form a remapped shortened link 320 including the unique identifier. In a particular embodiment, shortened link remapping component 314 appends the unique identifier to shortened link 318 to generated remapped shortened link 320. In an embodiment, if a subsequent user re-shares remapped short link 320 posted by the original user to the same or another social media site, unique identifier generation component 312 generates another unique identifier associated with the subsequent user using user profile information 308, and shortened link remapping component 314 remaps shortened link 318 to form a new remapped shortened link 320 including the unique identifier associated with the new user. For any additional subsequent users that re-share shortened link 318, application 302 remaps shortened link 318 to include an identifier associated with the particular additional subsequent user.

In the embodiment, analytics component 322 is configured to generate sharing analytics 322. In one or more embodiments, sharing analytics 322 include information tracking the re-sharing of the original user's posting of shortened link 318 by any subsequent users which also re-share shortened link 318 due to the unique identifier included with each re-shared link. Accordingly, a hierarchical structure is generated including sharing analytics tracking the identities of the original user and each subsequent user that shares the shortened link 318, as well as references to the user from which the subsequent user obtained the shortened link 318. For example, the original user can obtain information identifying which of the subsequent users sharing shortened link 318 have the greatest reach among subsequent users within one or more social networks by determining the subsequent user having the most re-shares from another subsequent user.

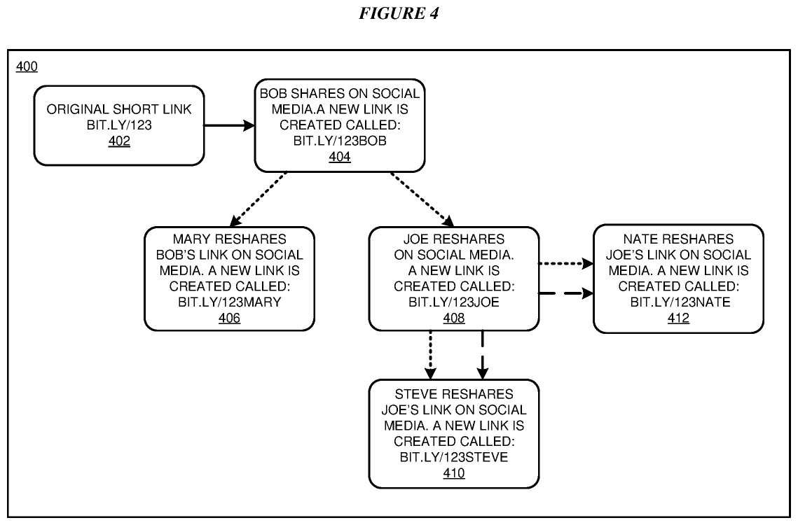

With reference to FIG. 4, this figure depicts an example shortened link sharing sequence 400 in accordance with an illustrative embodiment. In block 402, an original user, Bob, receives an original shortened link “bit.ly/123”. In block 404, Bob shares the original shortened link “bit.ly/123” on a social media site. In response, application 105 creates a new shortened link “bit.ly/123Bob” in which “Bob” is a unique identifier associated with Bob. In the particular example of FIG. 4, the unique identifier “Bob” is appended to the shortened link “bit.ly/123” to form the new shortened link “bit.ly/123Bob”.

In block 406, a subsequent user, Mary, re-shares Bob's link on the same or another social media site, and application 105 generates a new shortened link “bit.ly/123Mary” in which “Mary” is a unique identifier associated with Mary. In block 408, another subsequent user, Joe, re-shares Bob's link on the same or another social media site, and application 105 generates a new shortened link “bit.ly/123Joe” in which “Joe” is a unique identifier associated with Joe. In block 410, another subsequent user, Steve, re-shares Joe's link on the same or another social media site, and application 105 generates a new shortened link “bit.ly/123Steve” in which “Steve” is a unique identifier associated with Steve.

In block 412, another subsequent user, Nate, re-shares Joe's link on the same or another social media site, and application 105 generates a new shortened link “bit.ly/123Nate” in which “Nate” is a unique identifier associated with Nate.

In the example of FIG. 4, application 105 allows Bob to see impressions and analytics by influencers Mary, Joe, Steve, and Nate. Mary only sees her own impressions and analytics and none of her connections have re-shared Mary's link. Joe sees impressions and analytics by influencers Steve and Nate since both Steve and Nate have re-shared Joe's link. Steve only sees his own impressions and analytics since none of Steve's connections have re-shared Steve’ link, and Nate only see his own impressions and analytics since none of Nate's connections have re-shared Nate's link.

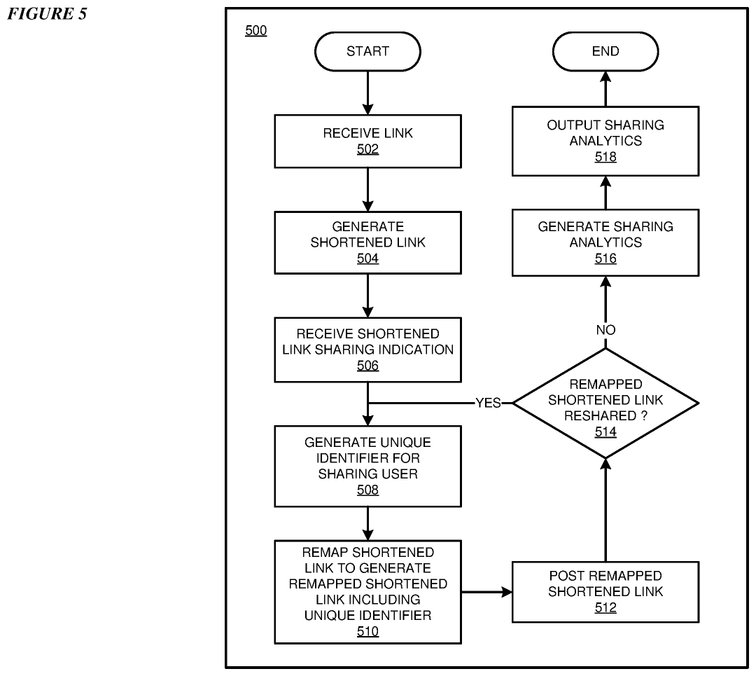

With reference to FIG. 5, this figure depicts a flowchart of an example process 500 for transforming a shortened link based upon a social event for tracking sharing analytics in accordance with an embodiment. In block 502, application 105 receives a link that a user desires to share on a social media site. In block 504, application 105 generates a shortened link from the received link in which the shortened link is shorter than the received link. In block 506, application 105 receives a shortened link sharing indication which indicates that the user has shared the shortened link on a social media site.

In block 508, application 105 generates a unique identifier for the sharing user for uniquely identify the user from among other users. In block 510, application 105 remaps the shortened link to generate a remapped shortened link including the unique identifier. In a particular embodiment, application 105 appends the unique identifier to the shortened link to generate the remapped shortened link. In block 512, application 105 posts the remapped shortened link to the social media site.

In block 514, application 105 determines whether the remapped shortened link has been re-shared by a subsequent user. If the remapped shortened link has been re-shared, process 500 returns to block 508 in which a unique identifier associated with the re-sharing user is generated (508), the shortened link is remapped to generate a remapped shortened link including the unique identifier (510), and the remapped shortened link is posted to a social media site (512). Accordingly, blocks 508, 510, and 512 are repeated for each user that re-shares the remapped shortened link. If the remapped shorted link has not been re-shared, process 500 proceeds to block 516.

In block 516, application 105 generates sharing analytics for the shortened link. In one or more embodiments, the sharing analytics include information tracking the re-sharing of the original user's posting of the shortened link by any subsequent users which also re-share the shortened link as well as and the extent of the sharing of the shortened link among one or more social media networks. In block 518, application 105 outputs the sharing analytics. In particular embodiments, the sharing analytics are output to the original user. Process 500 then ends.

Thus, a computer implemented method, system or apparatus, and computer program product are provided in the illustrative embodiments for transforming a shortened link based upon a social event for tracking sharing analytics and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for tracking sharing analytics for a shortened link, comprising:
receiving a network link referencing a network address associated with a network resource;
generating a first shortened link from the received network link;
mapping the first shortened link to a first mapped shortened link, the first mapped shortened link including a unique association of the shortened link with a first user; and
posting the first mapped shortened link to a social media site.

2. The method of claim 1, further comprising:
generating a unique identifier associated with the first user, the first mapped shortened link including the unique identifier.

3. The method of claim 2, further comprising:
appending the unique identifier to the first shortened link to generate the first mapped shortened link.

4. The method of claim 1, further comprising:
determining that the first mapped shortened link has been re-shared by a second user.

5. The method of claim 4, further comprising:
generating a second unique identifier associated with the second user; and
mapping the first shortened link to a second mapped shortened link, the second mapped shortened link including the second unique identifier associated with the second user.

6. The method of claim 1, further comprising:
generating sharing analytics for the first shortened link, the sharing analytics including information tracking re-sharing of the shortened link by the second user.

7. The method of claim 6, further comprising:
providing the sharing analytics to the first user.

8. The method of claim 7, wherein the sharing analytics includes a social influence of subsequent users that share the first shortened link.

9. A computer usable program product comprising one or more computer-readable storage devices, and program instructions stored on at least one of the one or more storage devices, the stored program instructions comprising:
program instructions to receive a network link referencing a network address associated with a network resource;
program instructions to generate a first shortened link from the received network link;
program instructions to map the first shortened link to a first mapped shortened link, the first mapped shortened link including a unique association of the shortened link with a first user; and
program instructions to post the first mapped shortened link to a social media site.

10. The computer usable program product of claim 9, further comprising:
program instructions to generate a unique identifier associated with the first user, the first mapped shortened link including the unique identifier.

11. The computer usable program product of claim 10, further comprising:
program instructions to append the unique identifier to the first shortened link to generate the first mapped shortened link.

12. The computer usable program product of claim 9, further comprising:
program instructions to determine that the first mapped shortened link has been re-shared by a second user.

13. The computer usable program product of claim 12, further comprising:
generating a second unique identifier associated with the second user; and
mapping the first shortened link to a second mapped shortened link, the second mapped shortened link including the second unique identifier associated with the second user.

14. The computer usable program product of claim 9, further comprising:
program instructions to generating sharing analytics for the first shortened link, the sharing analytics including information tracking re-sharing of the shortened link by the second user.

15. The computer usable program product of claim 14, further comprising:
program instructions to provide the sharing analytics to the first user.

16. The computer usable program product of claim 15, wherein the sharing analytics includes a social influence of subsequent users that share the first shortened link.

17. The computer usable program product of claim 9, wherein the computer usable code is stored in a computer readable storage device in a data processing system, and wherein the computer usable code is transferred over a network from a remote data processing system.

18. The computer usable program product of claim 9, wherein the computer usable code is stored in a computer readable storage device in a server data processing system, and wherein the computer usable code is downloaded over a network to a remote data processing system for use in a computer readable storage device associated with the remote data processing system.

19. A computer system comprising one or more processors, one or more computer-readable memories, and one or more computer-readable storage devices, and program instructions stored on at least one of the one or more storage devices for execution by at least one of the one or more processors via at least one of the one or more memories, the stored program instructions comprising:
program instructions to receive a network link referencing a network address associated with a network resource;
program instructions to generate a first shortened link from the received network link;
program instructions to map the first shortened link to a first mapped shortened link, the first mapped shortened link including a unique association of the shortened link with a first user; and
program instructions to post the first mapped shortened link to a social media site.

20. The computer usable program product of claim 19, the stored program instructions further comprising:
program instructions to generate a unique identifier associated with the first user, the first mapped shortened link including the unique identifier.
